(19) United States
(12) Patent Application Publication
(10) Pub. No.: US 2009/0116066 A1
(43) Pub. Date: May 7, 2009

(54) Sending device, information output device, presence server, content transmission system, and output condition transmission method

(75) Inventor: Masanobu Nishitani, Suwa-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/290,802

(22) Filed: Nov. 4, 2008

(30) Foreign Application Priority Data
Nov. 5, 2007 (JP) 2007-286955
Jan. 23, 2008 (JP) 2008-12957
Oct. 15, 2008 (JP) 2008-266290

(51) Int. Cl. G06F 3/12

(52) U.S. Cl. 358/1.15

(57) ABSTRACT

A printing terminal 108 registers in advance printing conditions adopted for printing based on content data into a SIP server 106 functioning as a presence server. A posting server 104 obtains the registered printing conditions from the SIP server 106, prior to transmission of the content data to the printing terminal 108. This arrangement enables the printing terminal 108 as an information output device to transmit the printing conditions as a desired output condition to a sending device.

### BACKGROUND OF THE INVENTION

1. Field of the Invention

The present invention relates to a technique of transmitting content data via a network. In the specification hereof, the terminology of ‘content’ means any of information like images and sounds, and ‘content data’ means data representing such contents. Among these contents, printable ones such as images may be specifically referred to as ‘print contents’.

2. Description of the Related Art

Companies generally deliver advertisements to their customers by mail or by facsimile. The mail and the facsimile are also used for delivery of materials for distance learning from correspondence organizations to their students.

The mail delivery system provides the respective customers or students with high-quality prints of advertisements or materials as print contents. The mail delivery system, however, requires the large manpower for the mail delivery, thus undesirably increasing the cost and taking rather long time for the delivery.

The facsimile delivery system, on the other hand, does not require the large manpower or the long time, compared with the mail delivery system. The facsimile delivery system, however, still needs the communication cost and does not provide the customers or students with the high-quality print contents.

The latest advancement of the Internet and other networks enables very low-cost transmission of information. The development of high-performance printers and complex machines enables relatively low-cost and high-quality printing in homes.

It is highly demanded to develop a system of enabling print content data to be delivered at low cost and with high quality via the Internet or another network from a sending device, such as a personal computer or a server, to a printing terminal, such as a printer or a complex machine.

Known techniques for transmission of information via a network are disclosed in, for example, Japanese Patent Laid-Open No. 2005-109701 and No. 2003-178028 and Patent Application Publication No. 2005-516320.

Prior to transmission of print contents from the sending device to the printing terminal in the system, how to notify the sending device of desired printing conditions, for example, the paper size and the printing quality, in the printing terminal is an important issue.

This issue is not restricted to transmission of print content data from a transmission terminal to a printing terminal. It is also important how to notify a transmission terminal of display conditions adopted for a display, such as a display resolution, prior to transmission of content data, such as images, from the transmission terminal to the display. Similarly it is important how to notify a transmission terminal of audio output conditions adopted for an audio device, such as a mute condition, prior to transmission of content data, such as sound, from the transmission terminal to the audio device.

In the description hereafter, the printing terminal, the display, and the audio device may be collectively referred to as an information output device. The printing conditions, the display conditions, and the audio output conditions may be collectively referred to as an output condition for output of information from the information output device.

### SUMMARY OF THE INVENTION

In order to solve the problem of the prior art described above, there would be a demand for enabling an information output device to transmit a desired output condition to a transmission terminal.

The present invention accomplishes at least part of the demand mentioned above and the other relevant demands by the following configurations applied to the sending device, the information output device, the presence server, the content transmission system, and the output condition transmission method.

According to one aspect, the present invention is directed to a sending device constructed to send content data to an information output device via a network. The sending device has a controller configured to obtain an output condition, which is adopted when the information output device outputs information based on the content data, from a presence server connecting with the network, prior to transmission of the content data to the information output device.

The sending device according to this aspect of the invention utilizes the presence server to obtain a desired output condition adopted by the information output device, prior to transmission of the content data to the information output device. This arrangement enables the content data according to the desired output condition adopted by the information output device to be sent from the sending device to the information output device. The information output device then gives an information output result satisfying the requirement, based on the content data.

In one preferable application of the sending device according to the above aspect of the invention, when the obtained output condition includes multiple selectable options of the output condition, the controller selects a desired option of the output condition out of the multiple selectable options of the output condition and sends the selected option of the output condition together with the content data to the information output device.

The sending device of this application sends the selected option of the output condition together with the content data to the information output device. The information output device is thus notified of which option of the output condition is selected for the received content data by the sending device out of the multiple selectable options of the output condition provided by the information output device.

In another preferable application of the sending device according to the above aspect of the invention, the controller processes the content data according to the obtained output condition and sends the processed content data to the information output device.

The content data is subjected to, for example, a resolution conversion process, a resizing process, or a color subtraction process according to the output condition.

The sending device of this application processes the content data according to the obtained output condition. This arrangement enables the content data to be processed into a state corresponding to the desired output condition adopted by the information output device and to be sent to the information output device.

In still another preferable application of the sending device according to the above aspect of the invention, the controller controls a processing server capable of processing the content data to process the content data according to the obtained output condition and sends the processed content data to the information output device.

The sending device of this application uses the processing server to process the content data according to the obtained output condition. Like the sending device of the above application, this arrangement enables the content data to be processed into a state corresponding to the desired output condition adopted by the information output device and to be sent to the information output device.

In another preferable application of the sending device according to the above aspect of the invention, when respective settings of the output condition are correlated to multiple sending devices and are registered in the presence server, the controller of each sending device obtains at least a corresponding setting of the output condition correlated to the sending device from the presence server.

In this application, the respective settings of the output condition corresponding to the multiple sending devices are registered in the presence server. The respective sending devices may have different desired settings of the output condition adopted by the information output device. Prior to transmission of the content data, the sending device of this application utilizes the presence server to obtain the corresponding setting of the output condition. This arrangement enables the content data according to the desired output condition adopted by the information output device to be sent from each of the multiple sending devices to the information output device. The information output device then gives an information output result satisfying the requirement of each sending device, based on the content data.

In one preferable embodiment of the invention, the sending device further has an image scanner configured to scan an image according to a scanning condition and obtain image data of the scanned image as the content data. The controller obtains the output condition from the presence server prior to the image scan by the image scanner, and sets the scanning condition corresponding to the obtained output condition.

In transmission of the image data of the image scanned by the image scanner as the content data, the sending device of this application utilizes the presence server to obtain the desired output condition adopted by the information output device, prior to the image scan by the image scanner. The image scanner then scans the image according to the obtained output condition. This arrangement enables the image data of the image scanned according to the customer's desired output condition to be sent as the content data to the information output device. The information output device then gives an information output result satisfying the customer's requirement.

In another preferable embodiment of the invention, the sending device further has an image scanner configured to scan an image according to a scanning condition and obtain image data of the scanned image as the content data. The controller causes the image scanner to scan the image according to a default scanning condition, obtains the output condition from the presence server, and compares the obtained output condition with the default scanning condition. When the obtained output condition is consistent with the default scanning condition, the controller sends the obtained content data to the information output device. When the obtained output condition is inconsistent with the default scanning condition, on the other hand, the controller processes the obtained content data according to the output condition and sends the processed content data to the information output device.

In transmission of the image data of the image scanned by the image scanner as the content data, the sending device of this application utilizes the presence server to obtain the desired output condition adopted by the information output device, while causing the image scanner to scan the image according to the default scanning condition. The sending device of this application compares the obtained output condition with the default scanning condition. When the obtained output condition is consistent with the default scanning condition, the obtained content data is directly sent to the information output device. When the obtained output condition is inconsistent with the default scanning condition, on the other hand, the obtained content data is processed according to the obtained output condition and the processed content data is sent to the information output device. This arrangement enables the information output device to give an information output result satisfying the customer's requirement.

In another preferable application of the sending device according to the aspect of the invention, when there are multiple transmission terminals constructed to send the content data, the controller receives the content data from each of the multiple transmission terminals via the network. Prior to transmission of the content data received from each of the multiple transmission terminals to the information output device, the controller obtains at least a corresponding setting of the output condition correlated to the transmission terminal from the presence server.

This application of the sending device is adopted when there are multiple transmission terminals constructed to send content data. The respective transmission terminals may have different desired settings of the output condition adopted by the information output device. Prior to transmission of content data from one of the multiple transmission terminals to the information output device, the sending device of this application utilizes the presence server to obtain the corresponding setting of the output condition correlated to the transmission terminal. This arrangement enables the content data according to the desired output condition adopted by the information output device with regard to each of the multiple transmission terminals to be sent from the sending device to the information output device. The information output device then gives an information output result satisfying the requirement of each transmission terminal, based on the content data.

Another aspect of the invention provides an information output device constructed to receive content data delivered from a sending device via a network and to output information based on the received content data. The information output device has a controller configured to register an output condition adopted for output of the information based on the content data into a presence server connecting with the network.

The information output device according to this aspect of the invention registers the output condition, which is adopted for output of information based on the content data, in the presence server. Prior to transmission of content data from the sending device to the information output device, the presence server is utilized to send a desired output condition adopted by the information output device to the sending device. This arrangement enables the content data according to the desired output condition adopted by the information output device to be sent from the sending device to the information output device. The information output device then gives an information output result satisfying the requirement, based on the content data.

In one preferable application of the information output device according to the above aspect of the invention, in response to an instruction for changing the output condition, the controller notifies the presence server of a change of the output condition.

In response to a change of the desired output condition, the information output device of this application notifies the presence server of the change of the output condition. This arrangement enables the output condition registered in the presence server to be updated immediately.

In another preferable application of the information output device according to the above aspect of the invention, when there are multiple sending devices, the controller registers a corresponding setting of the output condition correlated to each of the multiple sending devices into the presence server.

In this application, there are multiple sending devices. The respective sending devices may have different desired settings of the output condition adopted by the information output device. The respective settings of the output condition corresponding to the multiple sending devices are registered in the presence server. Prior to transmission of content data from one of the multiple sending devices to the information output device, the corresponding setting of the output condition correlated to the sending device is sent to the sending device by utilizing the presence server. This arrangement enables the content data according to the desired output condition adopted by the information output device with regard to each of the sending devices to be sent from the sending device to the information output device. The information output device then gives an information output result satisfying the requirement of each sending device, based on the content data.

In still another preferable application of the information output device according to the above aspect of the invention, when there are multiple transmission terminals constructed to send the content data to the sending device via the network, the controller registers a corresponding setting of the output condition correlated to each of the multiple transmission terminals into the presence server.

This application of the information output device is adopted when there are multiple transmission terminals. The respective transmission terminals may have different desired settings of the output condition adopted by the information output device. Prior to transmission of content data from one of the multiple transmission terminals to the information output device via the sending device, the corresponding setting of the output condition correlated to the transmission terminal is sent to the sending device by utilizing the presence server. This arrangement enables the content data according to the desired output condition adopted by the information output device with regard to each of the multiple transmission terminals to be sent from the sending device to the information output device. The information output device then gives an information output result satisfying the requirement of each transmission terminal, based on the content data.

Another aspect of the invention provides a presence server connected via a network with a sending device constructed to send content data and with an information output device constructed to receive the content data from the sending device and output information based on the received content data. The presence server has: a storage module configured to register an output condition, which is adopted by the information output device for output of the information based on the content data; and a controller configured to provide the sending device with the output condition registered in the storage module, prior to transmission of the content data from the sending device to the information output device.

This arrangement of the presence server exerts the same effects as those of the sending device and those of the information output device explained above.

In one preferable application of the presence server according to this aspect of the invention, when a change of the output condition is notified by the information output device, the controller changes the registered output condition according to the notification.

The presence server of this application can thus immediately update the output condition registered therein.

According to another aspect, the invention is also directed to a content transmission system constructed to transmit content data via a network. The content transmission system includes: a sending device connected to the network to send the content data via the network; an information output device connected to the network to receive the content data from the sending device and to output information based on the received content data; and a presence server connected to the network. The information output device registers in advance an output condition, which is adopted for output of the information based on the content data, into the presence server. The sending device obtains the registered output condition from the presence server, prior to transmission of the content data to the information output device.

This arrangement of the content transmission system exerts the same effects as those of the sending device and those of the information output device explained above.

According to still another aspect, the invention is further directed to an output condition transmission method of transmitting an output condition adopted for output of information based on content data in a content transmission system constructed to transmit the content data via a network. The content transmission system includes: a sending device connected to the network to send the content data via the network; an information output device connected to the network to receive the content data from the sending device and to output information based on the received content data; and a presence server connected to the network. The output condition transmission method causes the information output device to register the output condition into the presence server. The output condition transmission method then causes the sending device to obtain the registered output condition from the presence server, prior to transmission of the content data to the information output device.

This arrangement of the output condition transmission method exerts the same effects as those of the sending device and those of the information output device explained above.

The present invention is not restricted to the sending device, the information output device, the presence server, the content transmission system, or the output condition transmission method described above. The present invention may be actualized by diversity of other applications, for example, computer programs configured to actualize any of the sending device, the information output device, the presence server, the content transmission system, and the output condition transmission method, and recording media in which such computer programs are recorded.

### BRIEF DESCRIPTION OF THE DRAWINGS

FIG. 1 is a block diagram schematically illustrating the configuration of a content transmission system in a first embodiment of the invention;

FIG. 2 is a block diagram showing the primary structure of a posting server included in the content transmission system of FIG. 1;

FIG. 3 is a block diagram showing the primary structure of a SIP server included in the content transmission system of FIG. 1;

FIG. 4 shows general classification of the SIP server;

FIG. 5 is a block diagram showing the primary structure of a printing terminal included in the content transmission system of FIG. 1;

FIG. 6 shows a sequence of session establishment between the posting server and the printing terminal in the content transmission system of FIG. 1;

FIG. 7 is a block diagram schematically illustrating the configuration of a content transmission system in a second embodiment of the invention;

FIG. 8 is a block diagram schematically illustrating the configuration of a content transmission system in a third embodiment of the invention;

FIG. 9 shows one example of a printing condition by-sender list;

FIG. 10 is a block diagram schematically illustrating the configuration of a content transmission system in a fourth embodiment of the invention;

FIG. 11 is a block diagram schematically illustrating the configuration of a content transmission system in a fifth embodiment of the invention; and

FIG. 12 is a block diagram showing the primary structure of a sending device included in the content transmission system of FIG. 11.

### DESCRIPTION OF THE PREFERRED EMBODIMENTS

Some modes of carrying out the invention are described below as preferred embodiments in the following sequence with reference to the accompanied drawings:

A. First Embodiment
A-1. System Configuration
A-2. System Operation
A-3. Effects of Embodiment

B. Second Embodiment
B-1. System Configuration
B-2. System Operation
B-3. Effects of Embodiment

C. Third Embodiment
C-1. System Configuration
C-2. System Operation
C-3. Effects of Embodiment

D. Fourth Embodiment
D-1. System Configuration
D-2. System Operation
D-3. Effects of Embodiment

E. Fifth Embodiment
E-1. System Configuration
E-2. System Operation
E-3. Effects of Embodiment

F. Sixth Embodiment
F-1. System Configuration
F-2. System Operation
F-3. Effects of Embodiment

G. Other Aspects

### A. First Embodiment

### A-1. System Configuration

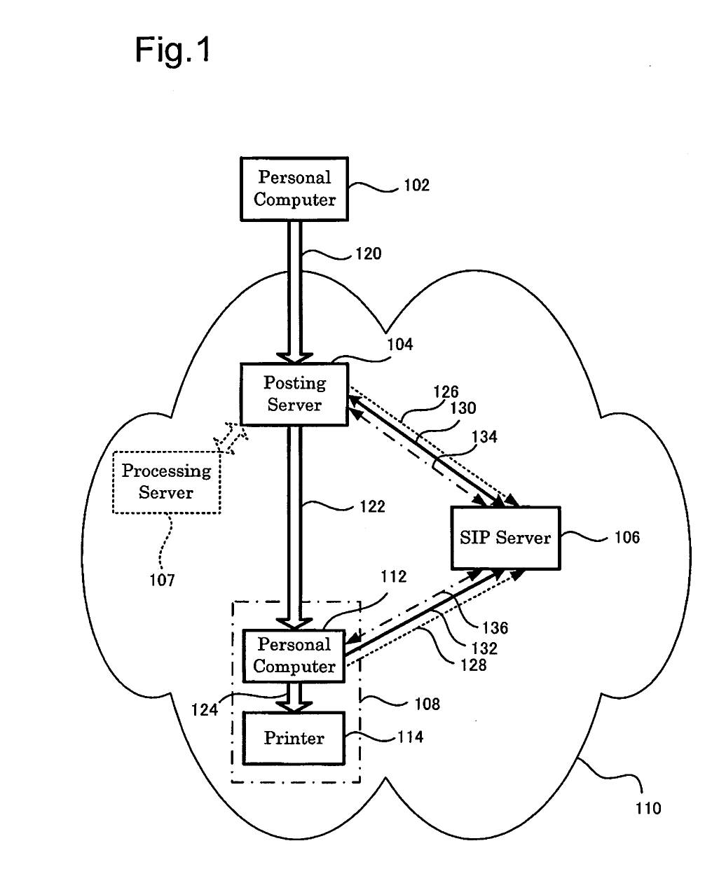

FIG. 1 is a block diagram schematically illustrating the configuration of a content transmission system in a first embodiment of the invention.

As shown in FIG. 1, the content transmission system of the first embodiment includes a personal computer 102 managed by a company desiring delivery of print contents (for example, advertisements or materials for distance learning), a posting server 104 and a SIP (Session Initiation Protocol) server 106 managed by at least one network service provider, and a printing terminal 108 as an information output device managed by a customer. The posing server 104 and the SIP server 106 may be managed by different network service providers or may be managed by one identical network service provider. The posting server 104, the SIP server 106, and the printing terminal 108 are interconnected via a broadband network 110, such as the Internet. The personal computer 102 may be connected with the posting server 104 via a broadband network or may otherwise be connected with the posting server 104 via a leased line. A processing server 107 connecting with the posting server 104 will be described later.

In the content transmission system of this embodiment, each print content, such as an advertisement or a material for distance learning, is sent as content data from the personal computer 102 to the posting server 104 and is delivered in a ‘push’ type by the posting server 104 to the printing terminal 108 as discussed later in detail. The content data used for such printing may be any of diverse data representing images and documents, for example, JPEG data, GIF data, PNG data, TIFF data, plain text data, HTML data, PDF data, and PostScript (registered trademark) data. When the model of a printer adopted for the printing terminal is known, the content data may be delivered in the form of print data. In the ‘push type’ delivery, a server unilaterally sends information to the terminal without any information request from the terminal.

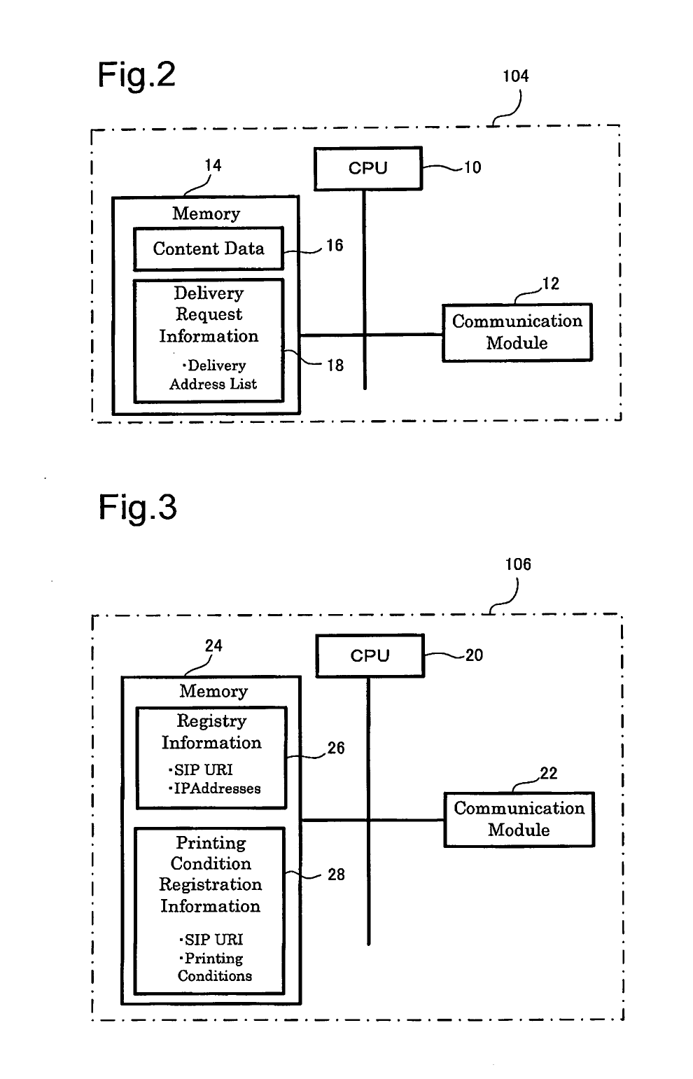

FIG. 2 is a block diagram showing the primary structure of the posting server 104 included in the content transmission system of FIG. 1. As shown in FIG. 2, the posting server 104 is constructed by a server computer and mainly includes a CPU 10 configured to perform diversity of processing operations and controls according to programs, a communication module 12 configured to transmit various data and information to and from other devices via a network, and a memory 14 configured to store programs as well as data and information therein. The memory 14 is capable of storing content data 16 and delivery request information 18 as part of the storable data and information as explained later. The posting server 104 also has an input unit, such as a keyboard and a pointing device, and a display unit, such as a monitor, in addition to the above primary components, although these additional components are omitted from the illustration.

In the content transmission system of this embodiment, prior to delivery of the content data, a session is established between devices by a SIP (Session Initiation Protocol) as one type of signaling protocol. HTTP (Hypertext Transfer Protocol) as one type of data transfer protocol is used for actual delivery of the content data or for transmission of the content data between the devices. The ‘session’ is established to allow transmission of media streams between terminals and other nodes.

FIG. 3 is a block diagram showing the primary structure of the SIP server 106 included in the content transmission system of FIG. 1. As shown in FIG. 3, like the posting server 104, the SIP server 106 is constructed by a server computer and mainly includes a CPU 20 configured to perform diversity of processing operations and controls according to programs, a communication module 22 configured to transmit various data and information to and from other devices via a network, and a memory 24 configured to store programs as well as data and information therein. The memory 24 is capable of storing registry information 26 and printing condition registration information 28 as part of the storable information as explained later. The SIP server 106 also has an input unit, such as a keyboard and a pointing device, and a display unit, such as a monitor, in addition to the above primary components, although these additional components are omitted from the illustration.

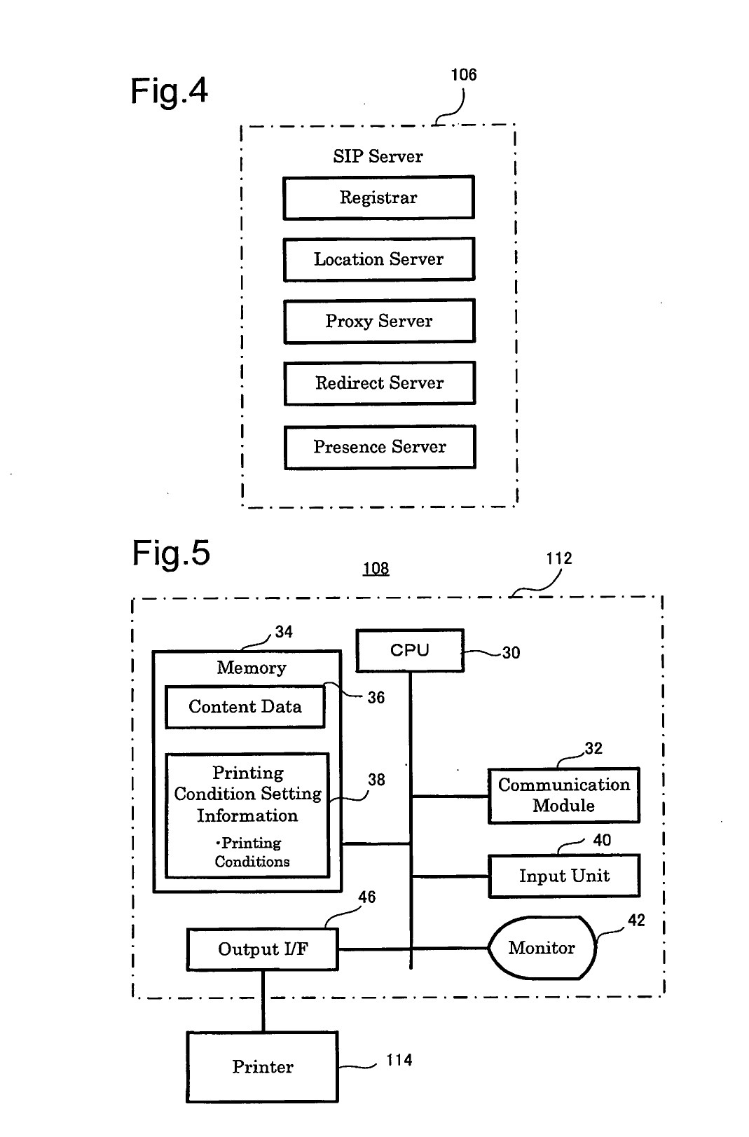

FIG. 4 shows general classification of SIP servers. The SIP servers are generally classified into multiple types of FIG. 4 according to its functions.

A registrar receives a registration request from each SIP client (SIP user agent) and registers an IP address (SIP URI (Uniform Resource Identifier)) and location information (for example, IP (Internet Protocol) address) of the SIP client into a location server.

The location server is a database for storing SIP addresses and location information of SIP clients and servers.

A proxy server relays requests and responses between SIP clients and mediates sessions between the SIP clients.

A redirect server notifies a SIP client of location information of a desired transmission destination in response to an inquiry from the SIP client.

A presence server obtains and manages presence information regarding each SIP client and provides another SIP client with the obtained and managed presence information.

The content transmission system of this embodiment utilizes the function of the SIP server 106 as the presence server and causes the SIP server 106 to store and manage desired printing conditions adopted for the printing terminal 108, for example, a desired paper size and a desired printing quality, as presence information. Prior to delivery of content data by the posting server 104, the printing conditions are given to the posting server 104. Here the expression of ‘desired printing conditions adopted for the printing terminal 108’ means printing conditions required by the customer who manages the printing terminal 108.

FIG. 5 is a block diagram showing the primary structure of the printing terminal 108 included in the content transmission system of FIG. 1. As shown in FIG. 1, the printing terminal 108 has a personal computer 112 and a printer 114 connected with the personal computer 112 by a USB cable or another equivalent means. As illustrated in FIG. 5, the personal computer 112 mainly includes a CPU 30 configured to perform diversity of processing operations and controls according to programs, a communication module 32 configured to transmit various data and information to and from other devices via a network, a memory 34 configured to store programs as well as data and information therein, an input unit 40 configured to enter the user's instructions and commands, for example, a keyboard and a pointing device, a monitor 42 configured to display the obtained data and information, and an output interface (I/F) 46 configured to output data to the externally connected printer 114 or another externally connected device. The memory 34 is capable of storing content data 36 and printing condition setting information 38 as part of the storable data and information as explained later.

In the content transmission system of this embodiment, the printing terminal 108 is constructed to have the personal computer 112 and the printer 114 directly connected with the personal computer 112 by the USB cable or another equivalent means. The printing terminal 108 is, however, not restricted to this construction but may have any of other various arrangements.

In one modified arrangement, the printer 114 may be replaced with a complex machine. In another modified arrangement, the printing terminal 108 may be constructed by the personal computer 112 and a network-ready complex machine or printer connected to the personal computer 112 via a LAN (local area network) by a LAN cable or another equivalent means. In still another modified arrangement, the printing terminal 108 may be constructed by the personal computer 112, a network adapter connected to the personal computer 112 via a LAN by a LAN cable or another equivalent means, and a complex machine or a printer connected to the network adapter by a USB cable or another equivalent means.

In another modified arrangement, the printing terminal 108 may be constructed by an IP (Internet Protocol) printing-compatible complex machine or printer alone. The IP printing-compatible complex machine or printer is able to directly handle global addresses, such as SIP URIs. Direct connection of the IP printing-compatible complex machine or printer to a broadband network, such as the Internet, via a broadband router accordingly allows data transmission to and from an external device on the network. Here the IP printing represents a printing mode satisfying the following conditions:

utilizing a network;

using a call control protocol, such as SIP, as a communication protocol;

allowing transmission of content data between corresponding terminals; and

allowing direct printing of content data without mediation of a personal computer or any other device.

The respective devices may be interconnected by wireless connection, such as a wireless LAN, Bluetooth, or infrared, instead of the wired connection using the cable.

Global IP addresses are allocated on the broadband network 110 like the Internet, while private IP addresses are generally allocated on a private network like a LAN. In such cases, there is a NAT (Network Address Translation) traversal problem. As is known in the art, the NAT traversal problem is solved by UPnP (Universal Plug and Play) technique, STUN (Simple Traversal of UDP through NAT) technique, TURN (Traversal Using Relay NAT), or ICE (Interactive Connectivity Establishment) technique.

The posting server 104, the SIP server 106, and the printing terminal 108 of this embodiment are respectively equivalent to the sending device, the presence server, and the information output device in the claims of the invention. The CPU 10 of the posting server 104, the CPU 20 of the SIP server 106, and the CPU 30 of the printing terminal 108 respectively correspond to the controller of the sending device, the controller of the presence server, and the controller of the information output device.

### A-2. System Operation

In the content transmission system of the embodiment, prior to delivery of content data, the function of the SIP server 106 as the presence server is utilized to transmit desired printing conditions adopted for the printing terminal 108 to the posting server 104 as mentioned previously.

In the content transmission system of FIG. 1, the posting server 104 and the printing terminal 108 are respectively activated to make access as SIP clients to the SIP server 106. Each of the posting server 104 and the printing terminal 108 outputs a registration request to the accessed SIP server 106 and sends information including its own SIP URI and IP address to the accessed SIP server 106 (broken line arrows 126 and 128). In this state, the SIP server 106 functions as both the registrar and the location server. In the SIP server 106, the CPU 20 accepts the registration request via the communication module 22 and registers the received information as the registration information 26 into the memory 24 as shown in FIG. 3.

The SIP server 106 accordingly has the registration information of the posting server 104 and the printing terminal 108. The registration information 26 includes a SIP URI and an IP address correlated to each terminal and is managed by the CPU 20.

The SIP URI is expressed by, for example, an identifier sequence ‘sip:user@west.com’. This identifier sequence has an identifier (scheme) ‘sip’ representing SIP on the head, a user identifier ‘user’ in the next place, and a host name ‘west.com’ after the at mark @. The user identifier may be a user ID or user phone number. The host name may be a fully qualified domain name FQDN or an IP address. The host name may be followed by a port number or another optional parameter. The SIP URI may be replaced by SIPS URI, which is a secure SIP URI. In this case, the scheme on the head is ‘sips’.

On completion of the SIP-related advance preparation, the customer is allowed to set printing conditions.

In the printing terminal 108 under the customer's management shown in FIG. 5, the customer operates the input unit 40 of the personal computer 112 to activate a specific program (not shown). The CPU 30 then executes the specific program to open a printing condition setting window (not shown) on the monitor 42. The customer subsequently operates the input unit 40 to enter the customer's desired printing conditions with regard to a selected content in the printing condition setting window. The printing conditions include, for example, a paper size (size A4, size B5, size L), a printing quality (quality level 1, quality level 2), and a printing color (chromatic, monochromatic).

In response to the customer's entry of the printing conditions through the operation of the input unit 40, the CPU 30 stores the input printing conditions as the printing condition setting information 38 into the memory 34. The CPU 30 reads the printing conditions included in the printing condition setting information 38 from the memory 34, and makes access to the SIP server 106 via the communication module 32 to send the printing conditions to the SIP server 106 (solid line arrow 132 in FIG. 1).

In this state, the SIP server 106 functions as the presence server shown in FIG. 4. In the SIP server 106 of FIG. 3, the CPU 20 receives the transmitted printing conditions via the communication module 22. The CPU 20 correlates the received printing conditions to the SIP URI of the printing terminal 108 as the sender of the printing conditions and stores the correlated printing conditions as the printing condition registration information 28 into the memory 24.

The desired printing conditions adopted for the printing terminal 108 are thus stored and managed as presence information in the SIP server 106.

In the printing terminal 108, the customer may further operate the input unit 40 of the personal computer 112 to give an instruction for changing the printing conditions in the printing condition setting window. The CPU 30 then changes the printing conditions included in the printing condition setting information 38 stored in the memory 34, in response to the customer's instruction. The CPU 30 then makes access to the SIP server 106 via the communication module 32 and notifies the SIP server 106 of the change of the printing conditions. The CPU 20 of the SIP server 106 receives the notification via the communication module 22, retrieves the printing condition registration information 28 stored in the memory 24 with the SIP URI of the printing terminal 108 as the sender of the printing conditions, and changes the printing conditions correlated to the SIP URI based on the received notification.

When the customer changes the desired printing conditions adopted for the printing terminal 108, the printing conditions stored as presence information in the SIP server 106 are immediately updated according to the above procedure.

The company provides content data as an object print content to be delivered and a delivery address list. The personal computer 102 sends the content data and delivery request information including the delivery address list to the posting server 104 (open arrow 120 in FIG. 1). The posting server 104 temporarily stores the received content data 16 and the received delivery request information 18 into the memory 14 as shown in FIG. 2.

The CPU 10 of the posting server 104 reads out the delivery request information 18 from the memory 14 and analyzes the delivery address list included in the delivery request information 18. The delivery address list includes the SIP URI of the printing terminal 108 as a delivery destination.

When the printing terminal 108 is specified as a receiver of the content data 16 according to the delivery address list, the CPU 10 makes access to the SIP server 106 via the communication module 12 and makes an inquiry about setting of the printing conditions with regard to the printing terminal 108 (solid line arrow 130 in FIG. 1). According to the concrete procedure, the CPU 10 sends the SIP URI of the printing terminal 108 included in the delivery address list to the SIP server 106 to make an inquiry.

The CPU 20 of the SIP server 106 shown in FIG. 3 receives the inquiry via the communication module 22 and retrieves the printing condition registration information 28 stored in the memory 24 with the received SIP URI. As mentioned previously, the desired printing conditions adopted for the printing terminal 108 are correlated to the SIP URI of the printing terminal 108 and are stored as the printing condition registration information 28 in the memory 24. The CPU 20 accordingly reads the printing conditions correlated to the received SIP URI from the memory 24 and sends back the printing conditions to the posting server 104 via the communication module 22 (solid line arrow 130 in FIG. 1).

The CPU 10 of the posting server 104 receives the printing conditions with regard to the printing terminal 108 via the communication module 12 and reads the content data 16 from the memory 14. The CPU 10 subsequently processes the content data 16 according to the received printing conditions and temporarily stores the processed content data in the memory 14. When the received printing conditions specify ‘size L for the paper size, quality level 1 for the printing quality, and monochromatic for the printing color’, the CPU 10 makes the content data 16 subjected to a resizing process, a resolution conversion process, and a color subtraction process to satisfy the received printing conditions, that is, size L, quality level 1, and monochromatic.

On completion of the delivery preparation of the content data to the printing terminal 108, the content transmission system of the embodiment establishes a session between the posting server 104 and the printing terminal 108 according to the SIP protocol and delivers the processed content data to the printing terminal 108 according to the HTTP protocol as explained below.

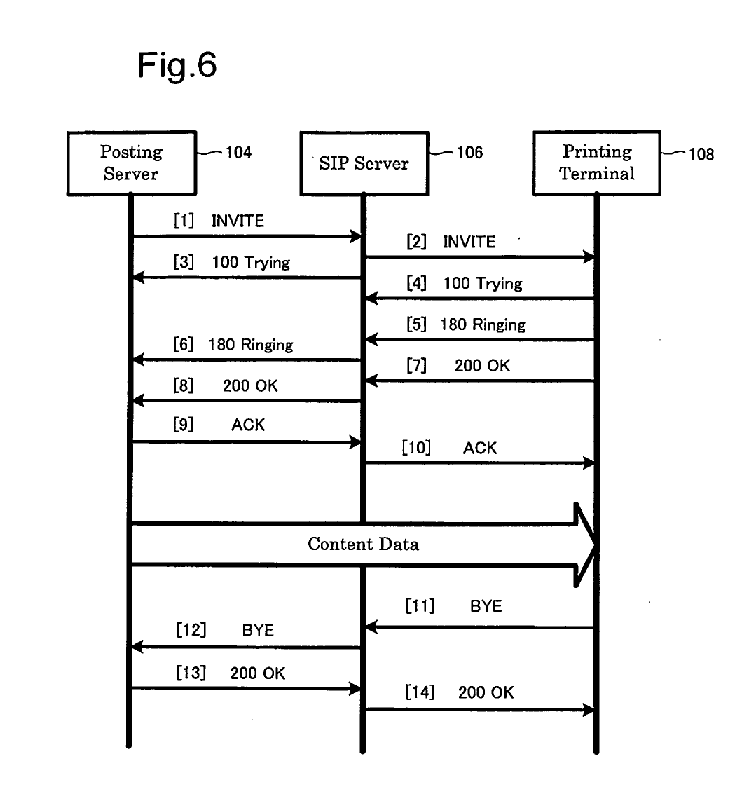

As shown in FIG. 1, the posting server 104 specifies the printing terminal 108 as a receiver and sends a request to the SIP server 106 (one-dot chain line arrow 134). In this state, the SIP server 106 functions as a proxy server. The SIP server 106 has the registration information with regard to the printing terminal 108 and relays the received request to the printing terminal 108 according to the registration information (one-dot chain line arrow 136). The personal computer 112 of the printing terminal 108 specifies the posting server 104 as a return address and sends back a response to the request to the SIP server 106 (one-dot chain line arrow 136). The SIP server 106 has the registration information with regard to the posting server 104 and relays the response to the posting server 104 according to the registration information (one-dot chain line arrow 134). The transmission of requests and responses between the posting server 104 and the printing terminal 108 in this manner establishes a session between the posting server 104 and the printing terminal 108. The details of the request and response transmission are shown in FIG. 6.

FIG. 6 shows a sequence of session establishment between the posting server 104 and the printing terminal 108 in the content transmission system of FIG. 1. The time flows from the top to the bottom of FIG. 6, and the processing sequence goes in the order of numbers in the brackets.

In order to notify the printing terminal 108 of the IP address of the posting server 104, the posting server 104 includes the own IP address in the body of an INVITE request message, which is to be sent to the printing terminal 108. Similarly in order to notify the posting server 104 of the IP address of the printing terminal 108, the printing terminal 108 includes the own IP address in the body of a 200 OK response message, which is to be sent to the pointing server 104.

When an ACK request message sent from the posting server 104 reaches the printing terminal 108, a session is established between the posting server 104 and the printing terminal 108.

The posting server 104 obtains the IP address of the printing terminal 108 from the received 200 OK response message and makes direct access to the printing terminal 108 based on the IP address of the printing terminal 108 without requiring mediation by the SIP server 106. In the posting server 104 of FIG. 2, the CPU 10 reads the processed content data from the memory 14 and delivers the processed content data in the ‘push’ type to the printing terminal 108 via the communication module 12 according to the HTTP protocol (open arrow 122 in FIG. 1).

In the personal computer 112 of the printing terminal 108 of FIG. 5, in response to reception of the delivered content data via the communication module 32, the CPU 30 temporarily stores the received content data as the content data 36 into the memory 34.

Referring back to FIG. 6, on completion of reception of the delivered content data, the printing terminal 108 sends a BYE request message to the posting server 104 via the SIP server 106 according to the SIP protocol. The posting server 104 receives the BYE request message and sends back a 200 OK response message to the printing terminal 108 via the SIP server 106. This closes the session between the posting server 104 and the printing terminal 108.

In the personal computer 112 of the printing terminal 108, the CPU 30 reads the content data 36 from the memory 34 and reads out the printing conditions included in the printing condition setting information 38. The CPU 30 refers to the printing conditions and makes the content data subjected to a desired series of processing to convert the content data into a data format printable by the printer 114. The CPU 30 then sends the converted content data with a printing instruction to the printer 114. In response to the printing instruction, the printer 114 performs printing according to the converted content data and outputs a print content as the printing result.

The printing terminal 108 accordingly gives the printing result of the delivered content data according to the customer's desired printing conditions.

In the description above, the desired printing conditions adopted for the printing terminal 108 are set as ‘size L for the paper size, quality level 1 for the printing quality, and monochromatic for the printing color’. The desired printing conditions adopted for the printing terminal 108 may, however, be given in the form of selectable options:

### Example 1

Paper size: size L or size A4

Printing Quality: quality level 1 or quality level 2

Printing Color: monochromatic

### Example 2

Paper Size: size L

Printing Quality: quality level 1

Printing Color: monochromatic; or

Paper Size: size A4

Printing Quality: quality level 3

Printing Color: Chromatic

When the selectable printing conditions are sent back from the SIP server 106, the CPU 10 of the posting server 104 selects the desired printing conditions among the available options. In the above example 2, there are two available options: ‘size L for the paper size, quality level 1 for the printing quality, and monochromatic for the printing color’ and ‘size A4 for the paper size, quality level 3 for the printing quality, and chromatic for the printing color’. The CPU 10 of the posting server 104 selects one of the two available options, for example, the latter option ‘size A4 for the paper size, quality level 3 for the printing quality, and chromatic for the printing color’. The CPU 10 processes the content data according to the selected printing conditions and transmits the processed content data together with the selected printing conditions to the printing terminal 108. The printing terminal 108 is then notified of the selection of the printing conditions by the posting server 104 out of the available options given as the desired printing conditions adopted for the printing terminal 108. The printing terminal 108 makes the selection by the posting server 104 reflected on printing of the content data.

One available method of transmitting the printing conditions with the content data from the posting server 104 to the printing terminal 108 may embed the printing conditions in the content data as the delivery object. An extended range of the data structure or the steganography technique may be utilized for such embedding. Another available method may provide the printing conditions as separate data, for example, in the form of text data, a barcode or a QR code. For transmission of the printing conditions, the existing protocol, for example, SDP (Session Description Protocol), may be uniquely extended. Alternatively the printing conditions may be correlated to the parameters of the existing protocol or may be defined as a unique protocol.

In the content transmission system of the embodiment described above, the posting server 104 processes the content data according to the printing conditions. As shown by a phantom box in FIG. 1, the processing server 107 may be connected with the posting server 104 directly or via a network to process the content data according to the printing conditions.

### A-3. Effects of Embodiment

The content transmission system of the first embodiment utilizes the function of the SIP server 106 as the presence server and transmits the desired printing conditions adopted for the printing terminal 108 to the posting server 104, prior to delivery of content data. The posting server 104 processes the content data according to the customer's desired printing conditions and delivers the processed content data to the printing terminal 108. The printing terminal 108 then outputs the print content as the printing result satisfying the customer's requirements.

### B. Second Embodiment

### B-1. System Configuration

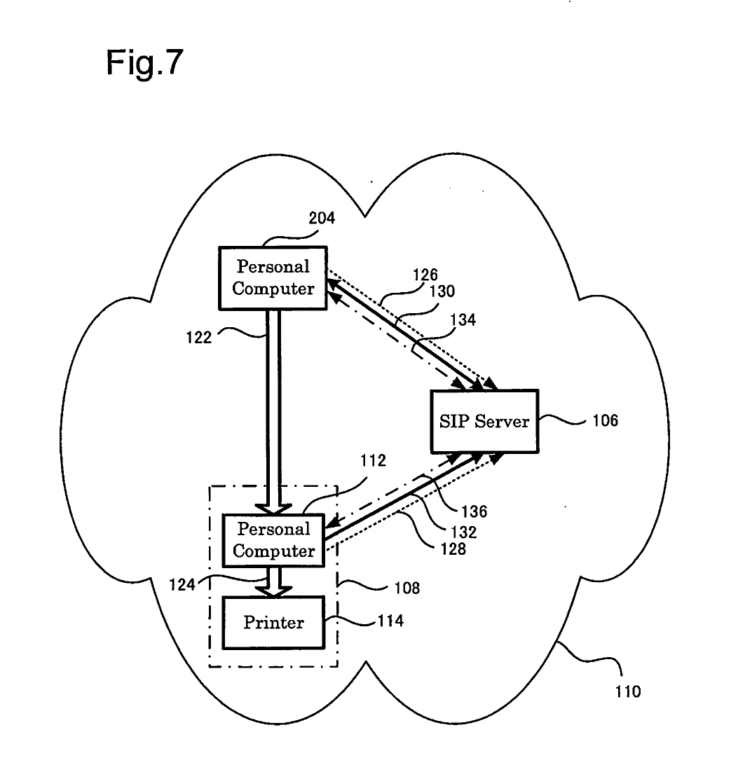

FIG. 7 is a block diagram schematically illustrating the configuration of a content transmission system in a second embodiment of the invention.

As shown in FIG. 7, the difference of the content transmission system of the second embodiment from the content transmission system of the first embodiment is that a personal computer 204 managed by the company desiring delivery of print contents directly delivers content data to the printing terminal 108 managed by the customer without using a posting server. Namely the personal computer 204 managed by the company has the function of the posting server. The posting server 104 included in the content transmission system of FIG. 1 is thus omitted from the content transmission system of FIG. 7. Otherwise the content transmission system of the second embodiment has the similar configuration to that of the content transmission system of the first embodiment. The same constituents are expressed by the like numerals and are not specifically described here.

The personal computer 204, the SIP server 106, and the printing terminal 108 of the embodiment are respectively equivalent to the sending device, the presence server, and the information output device in the claims of the invention.

### B-2. System Operation

In the content transmission system of FIG. 7, the personal computer 204 is activated to make access as a SIP client to the SIP server 106, output a registration request to the accessed SIP server 106, and send information including its own SIP URI and IP address to the accessed SIP server 106 (broken line arrow 126). The SIP server 106 accepts the registration request and registers the received information from the personal computer 204 as the registration information 26 into the memory 24. As described in the first embodiment, the registration information of the printing terminal 108 is also registered in the memory 24 of the SIP server 106. The desired printing conditions adopted for the printing terminal 108 are correlated to the SIP URI of the printing terminal 108 and are stored as the printing condition registration information 28 in the memory 24 of the SIP server 106.

The company provides content data as an object print content to be delivered and a delivery address list and stores the content data and the delivery address list in a memory (not shown) of the personal computer 204. The personal computer 204 performs a series of operations similar to those executed by the posting server 104 in the content transmission system of the first embodiment to obtain the desired printing conditions adopted for the printing terminal 108, process the content data according to the customer's desired printing conditions, and deliver the processed content data to the printing terminal 108. The printing terminal 108 performs printing according to the delivered content data and outputs a print content as the printing result.

### B-3. Effects of Embodiment

Like the content transmission system of the first embodiment, the content transmission system of the second embodiment utilizes the function of the SIP server 106 as the presence server and transmits the desired printing conditions adopted for the printing terminal 108 to the personal computer 204, prior to delivery of content data. The personal computer 204 processes the content data according to the customer's desired printing conditions and delivers the processed content data to the printing terminal 108. The printing terminal 108 then outputs the print content as the printing result satisfying the customer's requirements.

### C. Third Embodiment

### C-1. System Configuration

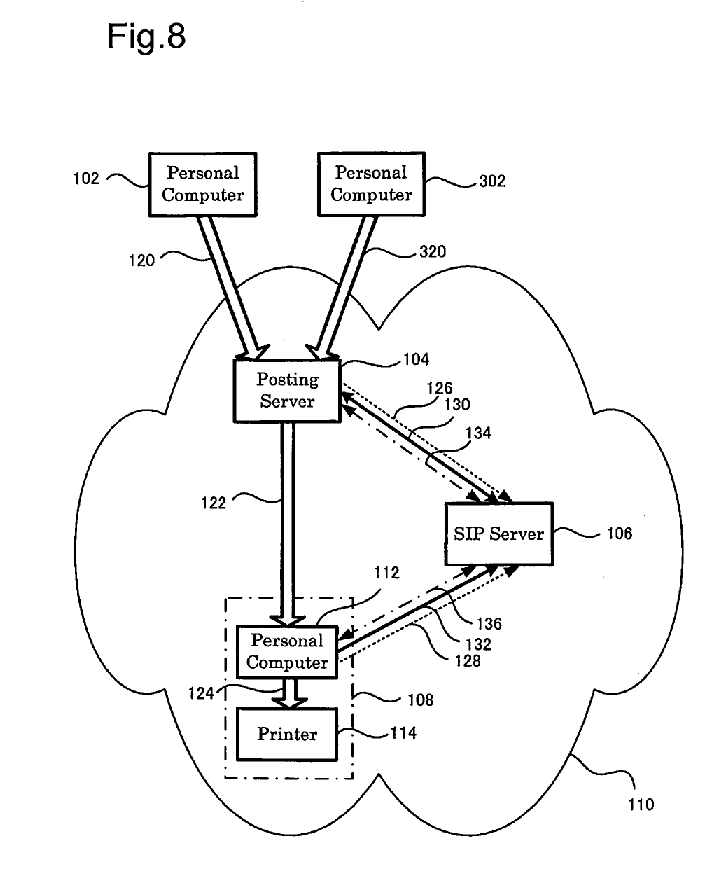

FIG. 8 is a block diagram schematically illustrating the configuration of a content transmission system in a third embodiment of the invention.

As shown in FIG. 8, the difference of the content transmission system of the third embodiment from the content transmission system of the first embodiment is that multiple companies specified as senders of content data individually manage personal computers 102 and 302 and that different sets of desired printing conditions adopted for the printing terminal 108 are specified for the respective senders and are transmitted to the posting server 104. In the content transmission system of FIG. 8, the personal computer 102 is managed by a company A, while the personal computer 302 is managed by a different company B. Otherwise the content transmission system of the third embodiment has the similar configuration to that of the content transmission system of the first embodiment. The same constituents are expressed by the like numerals and are not specifically described here.

The personal computers 102 and 302 of the embodiment are equivalent to the transmission terminals in the claims of the invention. The posting server 104, the SIP server 106, and the printing terminal 108 of the embodiment are respectively equivalent to the sending device, the presence server, and the information output device in the claims of the invention.

### C-2. System Operation

In the content transmission system of the third embodiment, the registration information of the posting server 104 and the registration information of the printing terminal 108 are registered in the SIP server 106, as described above in the first embodiment.

The customer operates the input unit 40 of the personal computer 112 in the printing terminal 108 to activate a specific program. The CPU 30 then executes the specific program to open a printing condition setting window on the monitor 42. The customer further operates the input unit 40 to enter desired printing conditions for each sender as a potential delivery source of content data. In the content transmission system of this embodiment, the respective companies as senders are managed by sender IDs. The customer accordingly enters each sender ID as a potential delivery source of content data in correlation with the customer's desired printing conditions for the content data delivered from the sender.

In response to the customer's entry of the desired printing conditions correlated to each sender ID via the input unit 40, the CPU 30 creates a printing condition by-sender list representing the correlation of the printing conditions to each sender ID and stores the printing condition by-sender list as the printing condition setting information 38 into the memory 34.

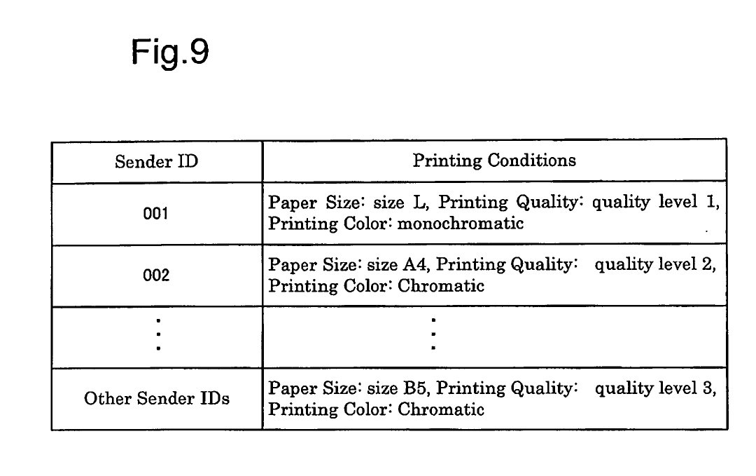

FIG. 9 shows one example of the printing condition by-sender list. In the list of FIG. 9, sender IDs as potential delivery sources of content data are enumerated in a sender ID column. The desired printing conditions adopted for the printing terminal 108 are correlated to each sender ID and are shown in a printing condition column.

In the list of FIG. 9, for example, the ‘sender ID: 001’ and the ‘sender ID: 002’ respectively represent the company A managing the personal computer 102 and the company B managing the personal computer 302 shown in FIG. 8. According to the printing condition by-sender list of FIG. 9, the customer's desired printing conditions for the content data delivered from the personal computer 102 (sender ID: 001) are ‘size L for the paper size, quality level 1 for the printing quality, and monochromatic for the printing color’. The customer's desired printing conditions for the content data delivered from the personal computer 302 (sender ID: 002) are ‘size A4 for the paper size, quality level 2 for the printing quality, and chromatic for the printing color’. In the list of FIG. 9, an option ‘other sender IDs’ will be explained later.

The CPU 30 reads the printing condition by-sender list included in the printing condition setting information 38 from the memory 34 and makes access to the SIP server 106 via the communication module 32 to send the printing condition by-sender list to the SIP server 106 (solid line arrow 132 in FIG. 8).

In this state, the SIP server 106 functions as the presence server. The CPU 20 of the SIP server 106 receives the printing condition by-sender list via the communication module 22, correlates the received printing condition by-sender list to the SIP URI of the printing terminal 108 as the sender of the list, and stores and manages the correlated printing condition by-sender list as the printing condition registration information 28 into the memory 24.

Each of the companies as the potential delivery source provides content data as an object print content to be delivered and a delivery address list. For example, the company A uses the personal computer 102 (sender ID: 001) under management to send the content data and delivery request information including the delivery address list to the posting server 104 (open arrow 120 in FIG. 8). The posting server 104 temporarily stores the received content data 16 and the received delivery request information 18 into the memory 14.

The CPU 10 of the posting server 104 reads out the delivery request information 18 from the memory 14 and analyzes the delivery address list included in the delivery request information 18. The delivery address list includes the SIP URI of the printing terminal 108 as a delivery destination.

When the printing terminal 108 is specified as a receiver of the content data 16 according to the delivery address list, the CPU 10 makes access to the SIP server 106 and makes an inquiry about setting of the printing conditions with regard to the printing terminal 108 (solid line arrow 130 in FIG. 8).

The CPU 20 of the SIP server 106 receives the inquiry and retrieves the printing condition registration information 28 stored in the memory 24 with the received SIP URI of the printing terminal 108. As mentioned previously, the printing condition by-sender list is correlated to the SIP URI of the printing terminal 108 and is stored as the printing condition registration information 28 in the memory 24. The CPU 20 accordingly reads the printing condition by-sender list correlated to the received SIP URI of the printing terminal 108 from the memory 24 and sends back the printing condition by-sender list to the posting server 104 (solid line arrow 130 in FIG. 8).

The CPU 10 of the posting server 104 analyzes the received printing condition by-sender list correlated to the printing terminal 108, and specifies the ‘sender ID: 001’ as the sender of the content data 16 stored in the memory 14. The CPU 10 then checks up the specified ‘sender ID: 001’ in the printing condition by-sender list and specifies the setting of the printing conditions ‘size L for the paper size, quality level 1 for the printing quality, and monochromatic for the printing color’ with regard to the ‘sender ID: 001’ as shown in FIG. 9. The CPU 10 subsequently processes the content data 16 according to the specified printing conditions and temporarily stores the processed content data in the memory 14.

On completion of the delivery preparation of the content data from the company A as the sender to the printing terminal 108, the content transmission system of the third embodiment establishes a session between the posting server 104 and the printing terminal 108 according to the SIP protocol and delivers the processed content data to the printing terminal 108 according to the HTTP protocol as explained in the first embodiment. The printing terminal 108 performs printing according to the delivered content data and outputs a print content as the printing result.

Similarly the company B uses the personal computer 302 (sender ID: 002) under management to send the content data and delivery request information including the delivery address list to the posting server 104 (open arrow 320 in FIG. 8). The posting server 104 temporarily stores the received content data 16 and the received delivery request information 18 into the memory 14.

As in the case of the company A described above, the delivery address list includes the SIP URI of the printing terminal 108 as a delivery destination. When the printing terminal 108 is specified as a receiver of the content data 16 according to the delivery address list, the posting server 104 obtains the printing condition by-sender list correlated to the printing terminal 108 from the SIP server 106 according to the procedure described above.

The CPU 10 of the posting server 104 analyzes the received printing condition by-sender list correlated to the printing terminal 108, and specifies the ‘sender ID: 002’ as the sender of the content data 16 stored in the memory 14. The CPU 10 then checks up the specified ‘sender ID: 002’ in the printing condition by-sender list and specifies the setting of the printing conditions ‘size A4 for the paper size, quality level 2 for the printing quality, and chromatic for the printing color’ with regard to the ‘sender ID: 002’ as shown in FIG. 9. The CPU 10 subsequently processes the content data 16 according to the specified printing conditions and temporarily stores the processed content data in the memory 14.

On completion of the delivery preparation of the content data from the company B as the sender to the printing terminal 108, the content transmission system of the third embodiment establishes a session between the posting server 104 and the printing terminal 108 according to the SIP protocol and delivers the processed content data to the printing terminal 108 according to the HTTP protocol. The printing terminal 108 performs printing according to the delivered content data and outputs a print content as the printing result.

The printing terminal 108 accordingly gives the printing result of the delivered content data according to the customer's desired printing conditions set with regard to each sender of the content data.

When the CPU 10 of the posting server 104 does not find the sender ID in the printing condition by-sender list, the sender ID is regarded as the ‘other sender IDs’ in the printing condition by-sender list of FIG. 9. The CPU 10 then specifies the setting of the printing conditions ‘size B5 for the paper size, quality level 3 for the printing quality, and chromatic for the printing color’ with regard to the sender ID and processes the content data according to the specified printing conditions.

### C-3. Effects of Embodiment

The content transmission system of the third embodiment is adopted when there are multiple senders of content data and different sets of desired printing conditions adopted for the printing terminal 108 are specified for the respective senders. The content transmission system of the third embodiment utilizes the function of the SIP server 106 as the presence server and transmits the printing condition by-sender list, which represents the correlation of the desired printing conditions to each sender, to the posting server 104, prior to delivery of content data. The posting server 104 processes the content data according to the customer's desired printing conditions with regard to each sender and delivers the processed content data to the printing terminal 108. The printing terminal 108 then outputs the print content as the printing result satisfying the customer's requirements with regard to each sender.

### D. Fourth Embodiment

### D-1. System Configuration

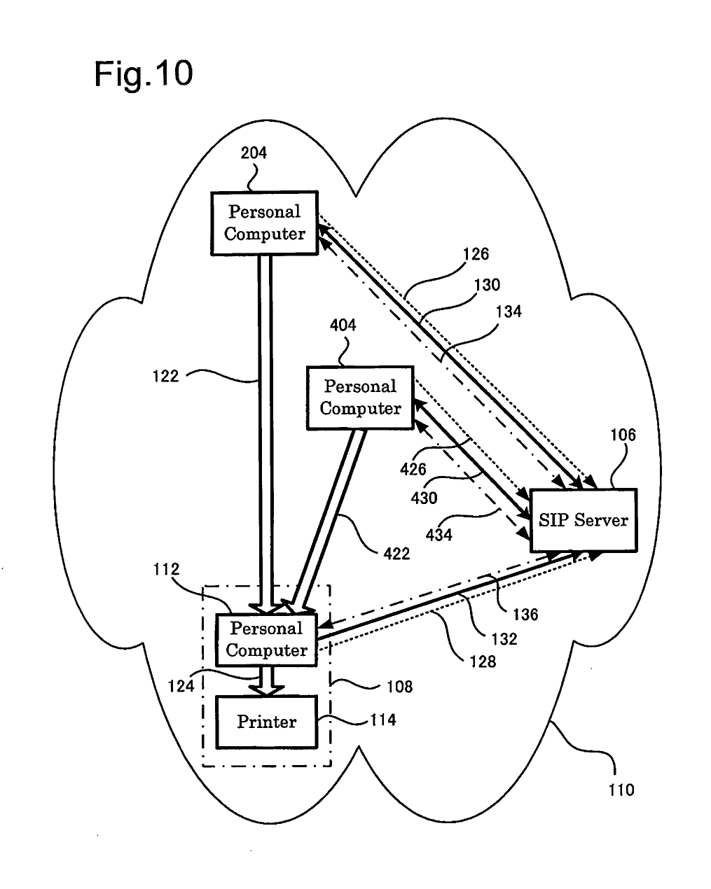

FIG. 10 is a block diagram schematically illustrating the configuration of a content transmission system in a fourth embodiment of the invention.

As shown in FIG. 10, the difference of the content transmission system of the fourth embodiment from the content transmission system of the third embodiment is that personal computers 204 and 404 managed by the respective senders as potential delivery sources directly deliver content data to the printing terminal 108 without using a posting server. In the content transmission system of FIG. 10, the personal computer 204 is managed by a company A, while the personal computer 404 is managed by a different company B. Otherwise the content transmission system of the fourth embodiment has the similar configuration to that of the content transmission system of the third embodiment. The same constituents are expressed by the like numerals and are not specifically described here.

The personal computers 204 and 404 of the embodiment are equivalent to the sending devices in the claims of the invention. The SIP server 106 and the printing terminal 108 of the embodiment are respectively equivalent to the presence server and the information output device in the claims of the invention.

### D-2. System Operation

In the content transmission system of FIG. 10, each of the personal computers 204 and 404 is activated to make access as a SIP client to the SIP server 106, output a registration request to the accessed SIP server 106, and send information including its own SIP URI and IP address to the accessed SIP server 106 (broken line arrows 126 and 426). The SIP server 106 accepts the registration requests and registers the received information from the personal computers 204 and 404 as the registration information 26 into the memory 24. As described in the first embodiment, the registration information of the printing terminal 108 is also registered in the memory 24 of the SIP server 106. The printing condition by-sender list shown in FIG. 9 is correlated to the SIP URI of the printing terminal 108 and is stored as the printing condition registration information 28 in the memory 24 of the SIP server 106.

Each of the companies as the potential delivery source provides content data as an object print content to be delivered and a delivery address list and stores the content data and the delivery address list in a memory (not shown) of the personal computer 204 or the personal computer 404 under management. For example, the company A uses the personal computer 204 (sender ID: 001) under management to analyze the stored delivery address list for delivery of the content data.

The delivery address list includes the SIP URI of the printing terminal 108 as a delivery destination. When the printing terminal 108 is specified as a receiver of the content data according to the delivery address list, the personal computer 204 makes access to the SIP server 106 and makes an inquiry about setting of the printing conditions with regard to the printing terminal 108 (solid line arrow 130 in FIG. 10).

The CPU 20 of the SIP server 106 receives the inquiry and retrieves the printing condition registration information 28 with the received SIP URI of the printing terminal 108. The CPU 20 then reads out the printing condition by-sender list correlated to the received SIP URI of the printing terminal 108 and sends back the printing condition by-sender list to the personal computer 204 (solid line arrow 130 in FIG. 10).

The personal computer 204 analyzes the received printing condition by-sender list correlated to the printing terminal 108. The personal computer 204 under management of the company A then checks up the ‘sender ID: 001’ of the company A in the printing condition by-sender list and specifies the setting of the printing conditions ‘size L for the paper size, quality level 1 for the printing quality, and monochromatic for the printing color’ with regard to the ‘sender ID: 001’ as shown in FIG. 9. The personal computer 204 subsequently processes the content data according to the specified printing conditions and temporarily stores the processed content data in the memory.

On completion of the delivery preparation of the content data from the company A as the sender to the printing terminal 108, the content transmission system of the fourth embodiment establishes a session between the personal computer 204 and the printing terminal 108 according to the SIP protocol and delivers the processed content data to the printing terminal 108 according to the HTTP protocol. The printing terminal 108 performs printing according to the delivered content data and outputs a print content as the printing result.

Similarly the company B uses the personal computer 404 (sender ID: 002) under management to analyze the stored delivery address list for delivery of the content data.

As in the case of the company A described above, the delivery address list includes the SIP URI of the printing terminal 108 as a delivery destination. When the printing terminal 108 is specified as a receiver of the content data according to the delivery address list, the personal computer 404 makes access to the SIP server 106 and makes an inquiry about setting of the printing conditions with regard to the printing terminal 108 (solid line arrow 430 in FIG. 10).

The CPU 20 of the SIP server 106 receives the inquiry and retrieves the printing condition registration information 28 with the received SIP URI of the printing terminal 108 as in the case of the company A described above. The CPU 20 then reads out the printing condition by-sender list correlated to the received SIP URI of the printing terminal 108 and sends back the printing condition by-sender list to the personal computer 404 (solid line arrow 430 in FIG. 10).

The personal computer 404 analyzes the received printing condition by-sender list correlated to the printing terminal 108. The personal computer 404 under management of the company B then checks up the ‘sender ID: 002’ of the company B in the printing condition by-sender list and specifies the setting of the printing conditions ‘size A4 for the paper size, quality level 2 for the printing quality, and chromatic for the printing color’ with regard to the ‘sender ID: 002’ as shown in FIG. 9. The personal computer 404 subsequently processes the content data according to the specified printing conditions and temporarily stores the processed content data in the memory.

On completion of the delivery preparation of the content data from the company B as the sender to the printing terminal 108, the content transmission system of the fourth embodiment establishes a session between the personal computer 404 and the printing terminal 108 according to the SIP protocol and delivers the processed content data to the printing terminal 108 according to the HTTP protocol. The printing terminal 108 performs printing according to the delivered content data and outputs a print content as the printing result.

### D-3. Effects of Embodiment

Like the content transmission system of the third embodiment, the content transmission system of the fourth embodiment is adopted when there are multiple senders of content data and different sets of desired printing conditions adopted for the printing terminal 108 are specified for the respective senders. The content transmission system of the fourth embodiment utilizes the function of the SIP server 106 as the presence server and transmits the printing condition by-sender list, which represents the correlation of the desired printing conditions to each sender, to the personal computers 204 and 404 under management of the respective senders as potential delivery sources, prior to delivery of content data. Each of the personal computers 204 and 404 processes the content data according to the customer's desired printing conditions with regard to the corresponding sender and delivers the processed content data to the printing terminal 108. The printing terminal 108 then outputs the print content as the printing result satisfying the customer's requirements with regard to each sender.

### E. Fifth Embodiment

In the content transmission system of the second embodiment described above, the company as the sender provides content data as an object print content to be delivered and stores the content data in the memory of the personal computer 204. The personal computer 204 obtains the desired printing conditions adopted for the printing terminal 108 from the SIP server 106, processes the content data according to the obtained printing conditions, and delivers the processed content data to the printing terminal 108.

This configuration is, however, neither essential nor restrictive. The sender may use a scanner to scan an image and deliver image data of the scanned image as content data. The sender may obtain the desired printing conditions adopted for the printing terminal from the SIP server prior to the image scan by the scanner and controls the image scan by the scanner according to the obtained printing conditions. Such configuration is described below as a fifth embodiment.

### E-1. System Configuration

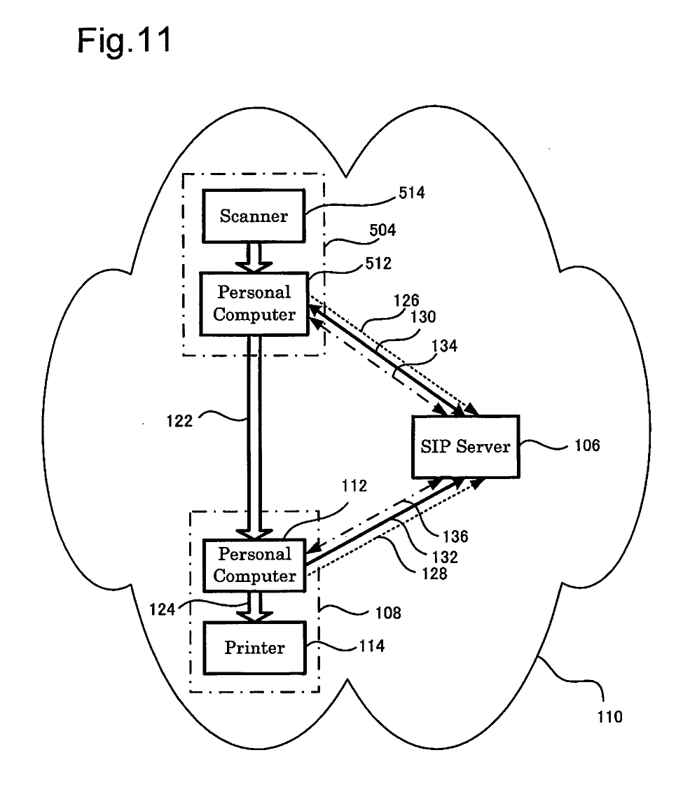

FIG. 11 is a block diagram schematically illustrating the configuration of a content transmission system in the fifth embodiment of the invention.

As shown in FIG. 11, the difference of the content transmission system of the fifth embodiment from the content transmission system of the second embodiment is that a sending device 504 under management of the company desiring delivery of print contents includes a personal computer 512 and a scanner 514 connected to the personal computer 512 by a USB cable or another equivalent means. Otherwise the content transmission system of the fifth embodiment has the similar configuration to that of the content transmission system of the second embodiment. The same constituents are expressed by the like numerals and are not specifically described here.

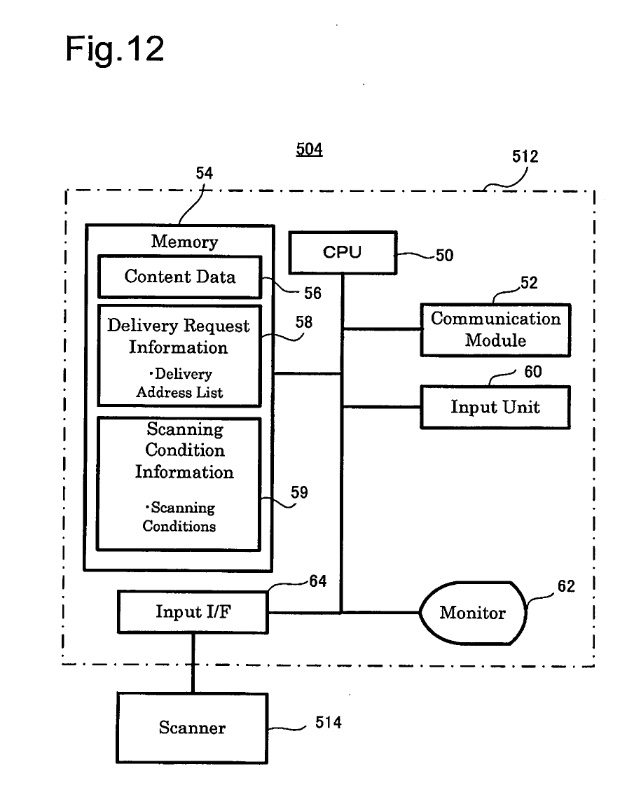

FIG. 12 is a block diagram showing the primary structure of the sending device 504 included in the content transmission system of FIG. 11. As shown in FIG. 12, the personal computer 512 mainly includes a CPU 50 configured to perform diversity of processing operations and controls according to programs, a communication module 52 configured to transmit various data and information to and from other devices via a network, a memory 54 configured to store programs as well as data and information therein, an input unit 60 configured to enter the user's instructions and commands, for example, a keyboard and a pointing device, a monitor 62 configured to display the obtained data and information, and an input interface (I/F) 64 configured to input data from the externally connected scanner 514 or another externally connected device. The memory 54 is capable of storing content data 56, delivery request information 58, and scanning condition information 59 as part of the storable data and information.

In the content transmission system of this embodiment, the sending device 504 is constructed to have the personal computer 512 and the scanner 514 directly connected with the personal computer 512 by the USB cable or another equivalent means. The sending device 504 is, however, not restricted to this construction but may have any of other various arrangements.

In one modified arrangement, the scanner 514 may be replaced with a complex machine. In another modified arrangement, the sending device 504 may be constructed by the personal computer 512 and a network-ready complex machine or scanner connected to the personal computer 512 via a LAN by a LAN cable or another equivalent means. In still another modified arrangement, the sending device 504 may be constructed by the personal computer 512, a network adapter connected to the personal computer 512 via a LAN by a LAN cable or another equivalent means, and a complex machine or a scanner connected to the network adapter by a USB cable or another equivalent means. In another modified arrangement, the sending device 504 may be constructed by an IP (Internet Protocol) printing-compatible complex machine alone.

The respective devices may be interconnected by wireless connection, such as a wireless LAN, Bluetooth, or infrared, instead of the wired connection using the cable.

The scanner 514 and the SIP server 106 of the embodiment are respectively equivalent to the image scanner and the presence server in the claims of the invention.

### E-2. System Operation

In the content transmission system of the fifth embodiment, the sending device 504 delivers the image data of the image scanned by the scanner 514 as content data. Prior to the image scan by the scanner 514, the sending device 504 obtains the desired printing conditions adopted for the printing terminal 108, specifies scanning conditions for the image scan by the scanner 514 according to the obtained printing conditions, and controls the image scan by the scanner 514 according to the specified scanning conditions.

In the content transmission system of FIG. 11, the personal computer 512 is activated to make access as a SIP client to the SIP server 106, output a registration request to the accessed SIP server 106, and send information including its own SIP URI and IP address to the accessed SIP server 106 (broken line arrow 126). The SIP server 106 accepts the registration request and registers the received information from the personal computer 512 as the registration information 26 into the memory 24. The registration information of the printing terminal 108 is also registered in the memory 24 of the SIP server 106. The desired printing conditions adopted for the printing terminal 108 are correlated to the SIP URI of the printing terminal 108 and are stored as the printing condition registration information 28 in the memory 24 of the SIP server 106.

The company provides a delivery address list for an object print content and stores delivery request information 58 including the delivery address list into the memory 54 of the personal computer 512. The CPU 50 of the personal computer 512 reads out the delivery request information 58 from the memory 54 and analyzes the delivery address list included in the delivery request information 58. The delivery address list includes the SIP URI of the printing terminal 108 as a delivery destination.

When the printing terminal 108 is specified as a receiver of the print content according to the delivery address list, the CPU 50 makes access to the SIP server 106 via the communication module 52 and makes an inquiry about setting of the printing conditions with regard to the printing terminal 108 (solid line arrow 130 in FIG. 11). According to the concrete procedure, the CPU 50 sends the SIP URI of the printing terminal 108 included in the delivery address list to the SIP server 106 to make an inquiry.

The CPU 20 of the SIP server 106 receives the inquiry and retrieves the printing condition registration information 28 stored in the memory 24 with the received SIP URI of the printing terminal 108. The CPU 20 then reads the printing conditions correlated to the received SIP URI of the printing terminal 108 from the memory 24 and sends back the printing conditions to the personal computer 512 (solid line arrow 130 in FIG. 11).

The CPU 50 of the personal computer 512 receives the printing conditions correlated to the printing terminal 108 via the communication module 52, specifies scanning conditions for the image scan by the scanner 514 according to the received printing conditions, and stores the specified scanning conditions as the scanning condition information 59 in the memory 54. For example, the scanning conditions for the image scan by the scanner 514 may be specified as ‘size A4 for the original size, quality level 2 for the scanning quality, and chromatic for the scanning color’ according to the received printing conditions of ‘size A4 for the paper size, quality level 2 for the printing quality, and chromatic for the printing color’. In this manner, the CPU 50 specifies the scanning conditions corresponding to the received printing conditions.

The CPU 50 reads out the scanning condition information 59 from the memory 54 and transmits the scanning conditions included in the scanning condition information 59 to the scanner 514 via the input I/F 64. The CPU 50 then gives a start command of the image scan and causes the scanner 514 to start the image scan according to the received scanning conditions. When the scanner 514 outputs image data of the scanned image, the CPU 50 receives the image data via the input I/F 64 and stores the received image data as the content data 56 in the memory 54.

On completion of the delivery preparation of the content data to the printing terminal 108, the content transmission system of the fifth embodiment establishes a session between the personal computer 512 and the printing terminal 108 according to the SIP protocol and delivers the stored content data to the printing terminal 108 according to the HTTP protocol. The printing terminal 108 performs printing according to the delivered content data and outputs a print content as the printing result.

### E-3. Effects of Embodiment

In delivery of image data of the image scanned by the scanner 514 as content data, prior to the image scan by the scanner 514, the content transmission system of the fifth embodiment utilizes the function of the SIP server 106 as the presence server and transmits the desired printing conditions adopted for the printing terminal 108 to the sending device 504. The sending device 504 scans the image according to the desired printing conditions adopted for the printing terminal 108. This arrangement enables the sending device 504 to scan the image according to the customer's desired printing conditions and deliver the scanned image data as the content data to the printing terminal 108. The printing terminal 108 then outputs the print content as the printing result satisfying the customer's requirements.

### F. Sixth Embodiment

In the content transmission system of the fifth embodiment described above, the company as the sender obtains the desired printing conditions adopted for the printing terminal from the SIP server prior to the image scan by the scanner and controls the image scan by the scanner according to the obtained printing conditions.

This configuration is, however, neither essential nor restrictive. The sender may cause the scanner to scan an image according to default scanning conditions and determine the requirement for processing the scanned image data according to the printing conditions obtained from the SIP server. Such configuration is described below as a sixth embodiment.

### F-1. System Configuration

The configuration of a content transmission system in the sixth embodiment is identical with the configuration of the content transmission system in the fifth embodiment shown in FIGS. 11 and 12 and is thus not specifically explained here. In the content transmission system of the sixth embodiment, the default scanning conditions are stored as the scanning condition information 59 in the memory 54 of the personal computer 512.

The scanner 514 and the SIP server 106 of the embodiment are respectively equivalent to the image scanner and the presence server in the claims of the invention.

### F-2. System Operation

In the content transmission system of the sixth embodiment, the sending device 504 causes the scanner 514 to read an image according to the default scanning conditions, while obtaining the desired printing conditions adopted for the printing terminal 108 from the SIP server 106. The obtained printing conditions are compared with the default scanning conditions. When the obtained printing conditions are consistent with the default scanning conditions, the scanned image data is delivered as the content data. When the obtained printing conditions are inconsistent with the default scanning conditions, on the other hand, the scanned image data is processed according to the received printing conditions and is then delivered as the content data.

In the content transmission system of the sixth embodiment, the registration information of the personal computer 512 and the registration information of the printing terminal 108 are registered in the SIP server 106 as described above in the fifth embodiment. The desired printing conditions adopted for the printing terminal 108 are correlated to the SIP URI of the printing terminal 108 and are stored as the printing condition registration information 28 in the memory 24 of the SIP server 106.

The company provides a delivery address list for an object print content and stores delivery request information 58 including the delivery address list into the memory 54 of the personal computer 512. The CPU 50 of the personal computer 512 reads out the delivery request information 58 from the memory 54 and analyzes the delivery address list included in the delivery request information 58. The delivery address list includes the SIP URI of the printing terminal 108 as a delivery destination.

When the printing terminal 108 is specified as a receiver of the print content according to the delivery address list, the CPU 50 reads out the scanning condition information 59 from the memory 54 and transmits the default scanning conditions included in the scanning condition information 59 to the scanner 514 via the input I/F 64. The CPU 50 then gives a start command of the image scan and causes the scanner 514 to start the image scan according to the received default scanning conditions. When the scanner 514 outputs image data of the scanned image, the CPU 50 receives the image data via the input I/F 64 and stores the received image data as the content data 56 in the memory 54.

During the image scan by the scanner 514, the CPU 50 of the personal computer 512 makes access to the SIP server 106 via the communication module 52 and makes an inquiry about setting of the printing conditions with regard to the printing terminal 108 (solid line arrow 130 in FIG. 11). According to the concrete procedure, the CPU 50 sends the SIP URI of the printing terminal 108 included in the delivery address list to the SIP server 106 to make an inquiry.

The CPU 20 of the SIP server 106 receives the inquiry and retrieves the printing condition registration information 28 stored in the memory 24 with the received SIP URI of the printing terminal 108. The CPU 20 then reads the printing conditions correlated to the received SIP URI of the printing terminal 108 from the memory 24 and sends back the printing conditions to the personal computer 512 (solid line arrow 130 in FIG. 11).

The CPU 50 of the personal computer 512 compares the printing conditions adopted for the printing terminal 108 received via the communication module 52 with the default scanning conditions read from the memory 52 and determines whether the received printing conditions are consistent with or inconsistent with the default scanning conditions. In one example, the received printing conditions are ‘size A4 for the paper size, quality level 2 for the printing quality, and chromatic for the printing color’, while the default scanning conditions are ‘size A4 for the original size, quality level 2 for the scanning quality, and chromatic for the scanning color’. In this case, the CPU 50 determines that the received printing conditions are ‘consistent’ with the default scanning conditions, since all the size, quality, and color conditions are matched as ‘size A4’, ‘quality level 2’, and ‘chromatic’.

Upon determination of the ‘consistency’, the CPU 50 of the personal computer 512 establishes a session with the printing terminal 108 via the SIP server 106 according to the SIP protocol, reads the stored content data 56 from the memory 54, and directly delivers the content data to the printing terminal 108 according to the HTTP protocol. The printing terminal 108 performs printing according to the delivered content data and outputs a print content as the printing result.

In another example, the received printing conditions are ‘size L for the paper size, quality level 1 for the printing quality, and monochromatic for the printing color’, while the default scanning conditions are ‘size A4 for the original size, quality level 2 for the scanning quality, and chromatic for the scanning color’. In this case, the CPU 50 determines that the received printing conditions are ‘inconsistent’ with the default scanning conditions, since all the size, quality, and color conditions are mismatched as ‘size L’ against ‘size A4’, ‘quality level 1’against ‘quality level 2’, and ‘monochromatic’ against ‘chromatic’.

Upon determination of the ‘inconsistency’, the CPU 50 of the personal computer 512 reads the content data 56 from the memory 54, processes the content data 56 according to the received printing conditions, and stores the processed content data into the memory 54. For example, when the received printing conditions are ‘size L for the paper size, quality level 1 for the printing quality, and monochromatic for the printing color’, the CPU 50 makes the content data 56 subjected to a resizing process, a resolution conversion process, and a color subtraction process to satisfy the received printing conditions, that is, size L, quality level 1, and monochromatic. The CPU 50 of the personal computer 512 then establishes a session with the printing terminal 108 via the SIP server 106 according to the SIP protocol, reads the processed content data from the memory 54, and delivers the processed content data to the printing terminal 108 according to the HTTP protocol. The printing terminal 108 performs printing according to the delivered content data and outputs a print content as the printing result.

In still another example, the received printing conditions are ‘size A4 for the paper size, quality level 3 for the printing quality, and chromatic for the printing color’, while the default scanning conditions are ‘size A4 for the original size, quality level 2 for the scanning quality, and chromatic for the scanning color’. In this case, the CPU 50 still determines that the received printing conditions are ‘inconsistent’ with the default scanning conditions, since the quality condition is mismatched as ‘quality level 3’against ‘quality level 2’ with the size and color conditions matched as ‘size A4’ and ‘chromatic’. The CPU 50 accordingly processes the content data 56. Since only the quality condition has the difference, the CPU 50 makes the content data 56 subjected to only the resolution conversion process to satisfy the quality level 3.

In the content transmission system of the sixth embodiment, when even part of the received printing conditions is mismatched with the default scanning conditions, the CPU 50 determines that the received printing conditions are ‘inconsistent’ with the default scanning conditions and processes the content data. This arrangement is, however, neither essential nor restrictive. The CPU 50 may determine that the received printing conditions are ‘consistent’ with the default scanning conditions when part of the received printing conditions is matched with the default scanning conditions.

In the content transmission system of the sixth embodiment described above, the personal computer 512 processes the content data according to the printing conditions. As explained previously in the first embodiment, a processing server may be connected with the personal computer 512 directly or via a network to process the content data according to the printing conditions.

### F-3. Effects of Embodiment

In delivery of image data of the image scanned by the scanner 514 as content data, the content transmission system of the sixth embodiment utilizes the function of the SIP server 106 as the presence server to transmit the desired printing conditions adopted for the printing terminal 108 to the sending device 504, while causing the scanner 514 to scan the image according to the default scanning conditions. The sending device 504 subsequently compares the received printing conditions with the default scanning conditions. When the received printing conditions are consistent with the default scanning conditions, the scanned image data as the content data is directly delivered to the printing terminal 108. When the received printing conditions are inconsistent with the default scanning conditions, on the other hand, the scanned image data as the content data is processed according to the received printing conditions and the processed content data is delivered to the printing terminal 108. The printing terminal 108 then outputs the print content as the printing result satisfying the customer's requirements.

### G. Other Aspects

The embodiments and their applications discussed above are to be considered in all aspects as illustrative and not restrictive. There may be many modifications, changes, and alterations without departing from the scope or spirit of the main characteristics of the present invention.

In the content transmission system of the third embodiment or in the content transmission system of the fourth embodiment described above, the printing condition by-sender list correlated to the printing terminal 108 is sent from the SIP server 106 to the posting server 104 or to the personal computers 204 and 404. The posting server 104 or the personal computers 204 and 404 then check up the sender IDs in the received printing condition by-sender list. This configuration is, however, neither essential nor restrictive. In one modification, the posting server 104 sends the desired sender IDs as objects to be checked up to the SIP server 106, or the personal computers 204 and 404 under management of the respective companies send the sender IDs of the companies to the SIP server 106. The SIP server 106 then checks up the received sender IDs in the printing condition by-sender list and sends back the printing conditions set for the respective sender IDs to the posting server 104 or to the personal computers 204 and 404.

In the content transmission systems of the fifth and the sixth embodiments described above, the sending device 504 including a scanner is adopted in place of the personal computer 204 included in the content transmission system of the second embodiment shown in FIG. 7. In the content transmission system of the fourth embodiment shown in FIG. 10, the sending device 504 including a scanner may be adopted in place of each of the personal computers 204 and 404.

In the content transmission system of the first embodiment shown in FIG. 1 or in the content transmission system of the third embodiment shown in FIG. 8, the sending device 504 including a scanner may be adopted in place of the personal computer 102 or in place of each of the personal computers 102 and 302. The content transmission systems of the first and the third embodiments include the posting server 104. In these content transmission systems, the posting server 104 first receives the printing conditions from the SIP server 106, and the sending device 504 then receives the printing conditions from the posting server 104.

In the content transmission systems of the above embodiments, the printing terminal 108 is constructed by the personal computer 112 and the printer 114 directly connecting with the personal computer 112. The specific program is activated in the personal computer 112 of the printing terminal 108 to open the printing condition setting window on the monitor 42. The customer then enters the desired printing conditions through the operation of the input unit 40. In the printing terminal 108 constructed by the IP printing-compatible complex machine alone, the customer may enter the printing conditions in a printing condition setting window opened through the operation of an operation display panel.

In the content transmission systems of the above embodiments, the network is a broadband network, such as the Internet. The network may otherwise be, for example, a mobile telephone network or a public telephone network.

The content transmission systems of the above embodiments adopt SIP as the signaling protocol. This is, however, not restrictive, but any of H.323, MGCP (Media Gateway Control Protocol), and MEGACO (Media Gateway Control) may be used instead of SIP. The content transmission systems of the above embodiments adopt HTTP as the data transfer protocol. This is, however, not restrictive, but any of FTP, RTP (Realtime Transport Protocol), IRC (Internet Relay Chat), and TELNET may be used instead of HTTP. Diversity of similar techniques having the global address management function and the presence service function, for example, Skype (registered trademark) and Instant Messaging, may alternatively be used for the session establishment and for the data transfer.

In the content transmission systems of the above embodiments, the SIP server is used as the proxy server to mediate establishment of a session. The SIP protocol enables establishment of a session in peer-to-peer fashion as long as SIP clients are notified of the SIP URIs and IP addresses of the others. In this case, the SIP clients may directly establish a session without mediation of the SIP server.

In the content transmission systems of the above embodiments, content data is delivered in the ‘push’ type from the posting server to the printing terminal. This is, however, not restrictive, but the content data may be delivered in a ‘pull’ type. In the ‘pull’-type delivery, a terminal sends a request for data delivery to a server, and the server delivers data to the terminal in response to the request.

In the content transmission systems of the above embodiments, the IP addresses are used as location information on the network. MAC (Media Access Control) addresses may alternatively be used as location information on the network.

In the content transmission systems of the above embodiments, the delivery address list is used as the delivery destination information for delivery of content data. The delivery destination information is, however, not restricted to such a list form but may be any other suitable form to specify delivery destinations.

In the content transmission systems of the above embodiments, the printing conditions specify the paper size, the printing quality, and the printing color. The printing conditions may additionally include the paper type (plain paper, glossy paper) and the On/Off state of an APF (auto photo fine) function.

In the content transmission systems of the above embodiments, the printing terminal is used as the information output device. This is, however, not restrictive. The technique of the present invention is also applicable to transmission of display conditions including a display resolution from a display to a transmission terminal, prior to delivery of content data, such as an image, from the transmission terminal to the display. The technique of the invention is further applicable to transmission of audio output conditions including a mute condition from an audio device to a transmission terminal, prior to delivery of content data, such as sound, from the transmission terminal to the audio device. A telephone or a television set may also be used as the information output device.

Finally the present application claims the priorities based on Japanese Patent Application No. 2007-286955 filed on Nov. 5, 2007, No. 2008-12957 filed on Jan. 23, 2008, and No. 2008-266290 filed on Oct. 15, 2008, which are herein incorporated by reference.

What is claimed is:

1. A sending device constructed to send content data to an information output device via a network, the sending device comprising:
a controller configured to obtain an output condition, which is adopted when the information output device outputs information based on the content data, from a presence server connecting with the network, prior to transmission of the content data to the information output device.

2. The sending device in accordance with claim 1, wherein when the obtained output condition includes multiple selectable options of the output condition, the controller selects a desired option of the output condition out of the multiple selectable options of the output condition and sends the selected option of the output condition together with the content data to the information output device.

3. The sending device in accordance with claim 1, wherein the controller processes the content data according to the obtained output condition and sends the processed content data to the information output device.

4. The sending device in accordance with claim 1, wherein the controller controls a processing server capable of processing the content data to process the content data according to the obtained output condition and sends the processed content data to the information output device.

5. The sending device in accordance with claim 1, wherein when respective settings of the output condition are correlated to multiple sending devices and are registered in the presence server, the controller of each sending device obtains at least a corresponding setting of the output condition correlated to the sending device from the presence server.

6. The sending device in accordance with claim 1, the sending device further comprising:
an image scanner configured to scan an image according to a scanning condition and obtain image data of the scanned image as the content data,
wherein the controller obtains the output condition from the presence server prior to the image scan by the image scanner, and sets the scanning condition corresponding to the obtained output condition.

7. The sending device in accordance with claim 1, the sending device further comprising:
an image scanner configured to scan an image according to a scanning condition and obtain image data of the scanned image as the content data,
wherein the controller causes the image scanner to scan the image according to a default scanning condition, obtains the output condition from the presence server, and compares the obtained output condition with the default scanning condition,
when the obtained output condition is consistent with the default scanning condition, the controller sending the obtained content data to the information output device, and
when the obtained output condition is inconsistent with the default scanning condition, the controller processing the obtained content data according to the output condition and sending the processed content data to the information output device.

8. The sending device in accordance with claim 1, wherein when there are multiple transmission terminals constructed to send the content data, the controller receives the content data from each of the multiple transmission terminals via the network, and
prior to transmission of the content data received from each of the multiple transmission terminals to the information output device, the controller obtaining at least a corresponding setting of the output condition correlated to the transmission terminal from the presence server.

9. An information output device constructed to receive content data delivered from a sending device via a network and to output information based on the received content data, the information output device comprising:
a controller configured to register an output condition adopted for output of the information based on the content data into a presence server connecting with the network.

10. The information output device in accordance with claim 9, wherein in response to an instruction for changing the output condition, the controller notifies the presence server of a change of the output condition.

11. The information output device in accordance with claim 9, wherein when there are multiple sending devices, the controller registers a corresponding setting of the output condition correlated to each of the multiple sending devices into the presence server.

12. The information output device in accordance with claim 9, wherein when there are multiple transmission terminals constructed to send the content data to the sending device via the network, the controller registers a corresponding setting of the output condition correlated to each of the multiple transmission terminals into the presence server.

13. A presence server connected via a network with a sending device constructed to send content data and with an information output device constructed to receive the content data from the sending device and output information based on the received content data, the presence server comprising:
a storage module configured to register an output condition, which is adopted by the information output device for output of the information based on the content data; and
a controller configured to provide the sending device with the output condition registered in the storage module, prior to transmission of the content data from the sending device to the information output device.

14. The presence server in accordance with claim 13, wherein when a change of the output condition is notified by the information output device, the controller changes the registered output condition according to the notification.

15. A content transmission system constructed to transmit content data via a network, the content transmission system comprising:
a sending device connected to the network to send the content data via the network;
an information output device connected to the network to receive the content data from the sending device and to output information based on the received content data; and
a presence server connected to the network,
wherein the information output device registers in advance an output condition, which is adopted for output of the information based on the content data, into the presence server, and
the sending device obtains the registered output condition from the presence server, prior to transmission of the content data to the information output device.

16. In a content transmission system constructed to transmit content data via a network, an output condition transmission method of transmitting an output condition adopted for output of information based on the content data,
the content transmission system including: a sending device connected to the network to send the content data via the network; an information output device connected to the network to receive the content data from the sending device and to output information based on the received content data; and a presence server connected to the network,
the output condition transmission method comprising:
(a) causing the information output device to register the output condition into the presence server; and
(b) causing the sending device to obtain the registered output condition from the presence server, prior to transmission of the content data to the information output device.
